(19) United States
(12) Patent Application Publication
(10) Pub. No.: US 2013/0204651 A1
(43) Pub. Date: Aug. 8, 2013

(54) Automated Hotel Bell Desk Queuing System

(71) Applicants: Gokhan Gulec, Plantation, MI (US); Selim Esen, Plantation, FL (US)

(72) Inventors: Gokhan Gulec, Plantation, MI (US); Selim Esen, Plantation, FL (US)

(21) Appl. No.: 13/829,633

(22) Filed: Mar. 14, 2013

Related U.S. Application Data
(63) Continuation-in-part of application No. 13/250,111, filed on Sep. 30, 2011.

(51) Int. Cl. G06Q 10/06; G06Q 50/12

(52) U.S. Cl. CPC G06Q 10/06311; G06Q 50/12
USPC 705/7.13

(57) ABSTRACT

A wireless bellhop queuing, distribution, and management system comprising a centralized wireless communication system, a plurality of wireless handheld communication devices for entering information and communicating with the centralized system, and a tracking system which depicts the physical location of the bellhops or storage items in the facility. A system and method for satisfaction of customer or guest requests includes offering the assignment to the bellhops who are the closest to the customer and task to be accomplished.

### CROSS-REFERENCE TO RELATED APPLICATIONS

This is a continuation-in-part of U.S. patent application Ser. No. 13/250,110, filed on Sep. 30, 2011.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This invention relates generally to a bell desk queuing system, and more particularly, to an automated bell desk management and inventory system that communicates with bell desk employees and manages customer service, baggage, and other matters through a mobile communication network and handheld devices.

### BACKGROUND

Bell desk operations for receiving, delivering and managing customer baggage and related items and for providing other hotel services are typically done by paper and at times with unsophisticated computer programs. As a result, bags can be temporarily lost or difficult to find, retrieve and deliver, which creates customer dissatisfaction. At other times, bags and items may even be lost or allegedly lost. Another problem is the amount of time it may takes to fulfill customer requests, such as handling luggage, retrieving skis, ordering shoe shines, flower deliveries or other services and checking in and out of a room or changing a room. This is in part due to the inability to communicate with bell desk employees until they return to the bell desk. Moreover, the inability to have seamless communication with and monitoring of bell desk employees inhibits the ability to monitor the employees' performance and assign jobs. If there existed an automated bell desk management system that addressed these shortcomings, it would be well received. However, there are no such automated bell desk management systems known.

Based on the foregoing, there exists a need for hotel bell desk queuing system that tracks employees, luggage and bags, communicates with employees using mobile communication devices such as iPhones®, iPod Touch®, and iPads® to assign jobs and streamline employee communication for enhanced customer service. It is, therefore, to the effective resolution of the aforementioned problems and shortcomings of the prior art that the present invention is directed. The instant invention addresses the unfulfilled need in the prior art by providing an automated bell desk management system as contemplated by the instant invention disclosed herein.

### SUMMARY OF THE INVENTION

In light of the foregoing, it is an object of the present invention to provide a hotel bell desk queuing system for handling and maintaining customer luggage/bags (generally referenced herein as “bags”) and other customer property, such as skis, left with bell desk personnel.

It is another object of the present invention to provide a hotel bell desk queuing system that keeps track of the location of customer bags and other property provided to the bell desk personnel.

It is another object of the instant invention to provide a hotel bell desk queuing system that keeps track of the location of customer's bags and other property placed in the bell desk storage room.

It is also an object of the instant invention to provide a hotel bell desk queuing system that facilitates instant communication with hotel employees regardless of their location in the hotel.

It is an additional object of the instant invention to provide a hotel bell desk queuing system that streamlines hotel guests services for faster response times when a request is made while tracking employees.

It is also an object of the instant invention to provide a hotel bell desk queuing system that automatically records jobs selected from the system queue and the responsible employee selecting the jobs or enables the responsible employee to manually enter the accepted job into the system queue.

It is an additional object of the instant invention to provide a bell desk queuing system that can facilitate the even distribution of jobs to employees.

It is a further object of the instant invention to provide a bell desk queuing system that activates queues, assigns jobs and can provide lists of jobs to employees.

It is yet another object of the instant invention to provide a hotel bell desk queuing system that generates new queues.

It is yet a further object of the instant invention to provide a hotel bell desk queuing system that can monitor employee performance and that may award better performing employees with more jobs.

It is yet an additional object of the instant invention to provide a hotel bell desk queuing system that facilitates appropriate staffing of employees to avoid over or under staffing.

It is still another object of the instant invention to provide a hotel desk queuing system that handles guest check in, guest check out and room changes.

It is still another additional object of the instant invention to provide a hotel bell desk queuing system that reduces payroll while increasing efficiency.

In light of these and other objects, the instant invention provides a bell desk queuing system having two main sections, that is (1) a storage room system for handling bags and other customer property, such as skis, when they are checked in and checked out with the bell desk, and (2) a queued job distribution and monitoring system. To operate these systems the instant invention comprises a plurality of bell hop wireless mobile communication devices, a centralized bell desk wireless communication system and device, barcode customer property tickets that are created or preprinted for assigning to bags or other property handled by the bell desk, barcode location tags corresponding to locations in the storage room and throughout the hotel or other facility, software applications for operation on the communication devices, and a GPS tracking system. The bell desk employee mobile communication devices preferably comprise iPhones®, iPod Touch® or comparable substitutes and the centralized bell desk communication system and device preferably comprises an iPad® or comparable communication system and device.

The centralized wireless communication device is referred herein by different names and can provide most or all of the data and information needed for the centralized system. The centralized wireless communication device is, or can include, a bell captain desk or office, a management office in the facility, a computer station in the lobby, or the front desk of the facility, or merely a wireless communication device such as an iPad® that is associated with a database system which allows it to communicate directly with handheld mobile devices used by bellhops and also is able to transmit and receive graphic or audio signals and messages.

The “facility” that the present invention is designed for are hotels, particularly large hotels with many floors and/or towers. However, the invention should not be limited only to hotels or only to large hotels. Not only can it be used with hotels of all types and sizes, it also can be used with other buildings or facilities which utilize service attendants which receive and perform job assignments of any type.

The storage room process comprises a “receiving bags” and a “delivery process.” With the process for receiving bags, the customer brings their bags, skis or other property to the bell desk for storage or handling. The bellman assigns a preprinted barcode ticket or creates a barcode ticket for each bag/property, gives the customer a ticket receipt, scans the barcode tag attached to the bag/property, and can take a picture of each bag/property with the iPhone® or iPad®. The name of the customer can also be entered into the system. The bellman takes the bags/property inside the storage room, puts the bags/property into a spot that was previously numbered or “tagged” with a barcode location tag, scans the bag tickets and scans the barcode location tag to indicate the exact storage location in the storage room. That information is preferably entered into the memory of the centralized computer system.

The delivery process comprises a pick-up system for handling customer bags/property when the customer returns to pick up the items and a delivery system for handling the delivery of customer bags/property. In the pick-up system, when the customer returns to pick up their bags/property, the bell captain scans the bags/property ticket into the system. The system enters this request to the queue and sends the messages to the bellhop queue to bring the bags/property to the bell desk where the customer is located. The next or most available bellhop selects the queued request form the list in the system and retrieves the bags/property from the proper storage location in the storage room and delivers it to the customer. The bellhop then scans the customer tag to tell the system that the bags/property has been delivered to the guest. The job is then removed from the queue. With respect to the delivery system, once the customer checks in, the bell captain will check the queue list for the next or most available bellhop and assigns the bags/property to the bellman for delivering to the customer's room. Whoever is next available picks up the bags/property and delivers them to the guest room and scans the barcode door tag from the room, which informs the system that the bags/property were delivered to the appropriate room and that the bellhop is then available to receive the next queue. The most available bellhop is typically the bellhop who has just completed a job assignment in the storage room, such as storing another customer's bags, and is still physically located in the storage room.

In addition to the bag/ski/coatroom process, the bellhops are required to provide additional services, such as room pickup and delivery services, room changes and anything related to guest services. The queued job distribution and monitoring system generally referenced herein as “queued job distribution system” facilitates servicing the guest as fast and as efficiently as possible, while keeping track of the location of each employee. The system also can evenly distribute the guest requests to each employee and provide staffing of the proper amount of employees to promptly satisfy guests' requests. The queued jobs distribution system enhances hotel services efficiency by tracking jobs and employees, distributing the queued jobs and monitoring employee performance. The queued jobs distribution system runs on iPhones® or iPod® Touch devices which are supplied to all bellhops and other necessary employees. The bell captain is assigned an iPad® or comparable substitute to communicate with the employees via their iPhones®, iPod® Touch or similar devices. The bell captain also has a centralized computer network with the appropriate database to operate the job distribution system. Jobs are queued manually or automatically into the system when a guest calls in a request, or sends a message with the request. In the manual process, the employee that receives the call or message with a job enters the job into the queue. In the automatic system, the system receives calls, text messages or emails with job requests and automatically enters them into the queue.

For speed and efficiency, the system assigns new job assignments to bellhops who have completed existing assignments and are in the location or area of the facility where another job assignment is in the queue and needs to be serviced.

Once a job is in the queue, the system can distribute the job according to predefined preferences, such as by employee location, which is determined, for example, by a GPS tracking system. Other preferences could include the first employee to select a queue job, or the employee(s) with the best performance history. In the first scenario, jobs distributed by employee location are determined by the system's physical location tracking system, such as a GPS system. The employee that is closest to the requested job area receives the job order from the queue. For instance, if the employee is delivering something (such as a bag) to a room or otherwise assisting a customer in a certain room, or in a certain floor, or in a certain portion of the building, any queued job which requests the presence and assistance of a bellhop in or at a location near or adjacent to his or her current location, will be first sent to that bell person or his or her iPhone®, iPod®, or other handheld device. It is up to the bellhop to accept or deny the new job assignment. If the job is denied by the first bellhop, the system then sends the queued job to the next closest employee, and so on.

In one embodiment of the invention, the physical locations of all of the bellhops in the facility are disclosed on a monitor screen or the like, so that a bell captain, manager or centralized control distribution person can visually see the precise locations of all the bellhops which then allow distribution of job assignments to appropriate bellhops. Preferably, a visual map of the facility is available at the bell desk or centralized wireless communication system that shows the locations of all the bellhops in the facility.

In the second scenario, new jobs are assigned based on the first employee to select the job in the queue, which works well during busy hours. In this scenario, the system lists the queued jobs so that the first employee to select the job, gets the job, performs the job and notifies the system when it is complete. Once a queued job is selected, the job is removed from the other employees' queue so that they cannot see or select the job. Meanwhile, the bell desk bell captain is able to see the list of “assigned queues” at any time so if there is any delay, they can act quickly to reassign the job.

The third scenario for assigning new jobs is based on employee performance. In the performance related distribution process, the system is able to distribute jobs according to bellmen's previous job performances. This allows strong performing employees to be given the chance to receive more jobs and earn more tips.

One of the objects of the invention is to improve efficiency of the system and improve service to customers. This can be accomplished by identifying those employees that are available and that are next in line to receive new jobs. To help accomplish this, the system includes a manual “delivery” option for each job so the bellmen can quickly indicate performance once the job is completed or “delivered.” With this procedure, the system is updated continuously to indicate the jobs that are completed. This also indicates that the bellhop is available for another job assignment.

In one of the preferred embodiments of the invention, electronic readable indicia (such as barcodes) are positioned on or adjacent rooms or areas of the building so that the bellhops can scan the indicia into the system with the handheld devices. For example, barcode labels can be applied or installed at each room or at adjacent areas identifying each room or area, and which can be scanned.

In accordance with these and other objects, which will become apparent hereinafter, the instant invention will now be described with particular reference to the accompanying drawings.

### BRIEF DESCRIPTION OF THE DRAWINGS

FIG. 1 is a diagram illustrating the overall system flow of the hotel bell desk queuing system in accordance with an embodiment of the invention.

FIG. 2 is a screen shot view of a representative main screen of the hotel bell desk queuing system in accordance with an embodiment of the invention.

FIG. 3 is a screen shot view of an example of the active pending queues screen in accordance with an embodiment of the invention.

FIG. 4 is a screen shot view of an example of the assigned requests queues screen in accordance with an embodiment of the invention.

FIG. 5 is a screen shot view of the bags/luggage main screen in accordance with an embodiment of the invention.

FIG. 6 is a screen shot view of an example of bags transaction screen in accordance with an embodiment of the invention.

FIG. 7 is a screen shot of the employees' monitoring screen in accordance with an embodiment of the invention

FIG. 8 is a view of a representative bag and customer barcode ticket, luggage, luggage storage area and barcode location tag in accordance with a hotel bell desk queuing system in accordance with an embodiment of the invention.

FIGS. 9-15 schematically illustrate another preferred embodiment of the invention.

### DESCRIPTION OF THE PREFERRED EMBODIMENTS

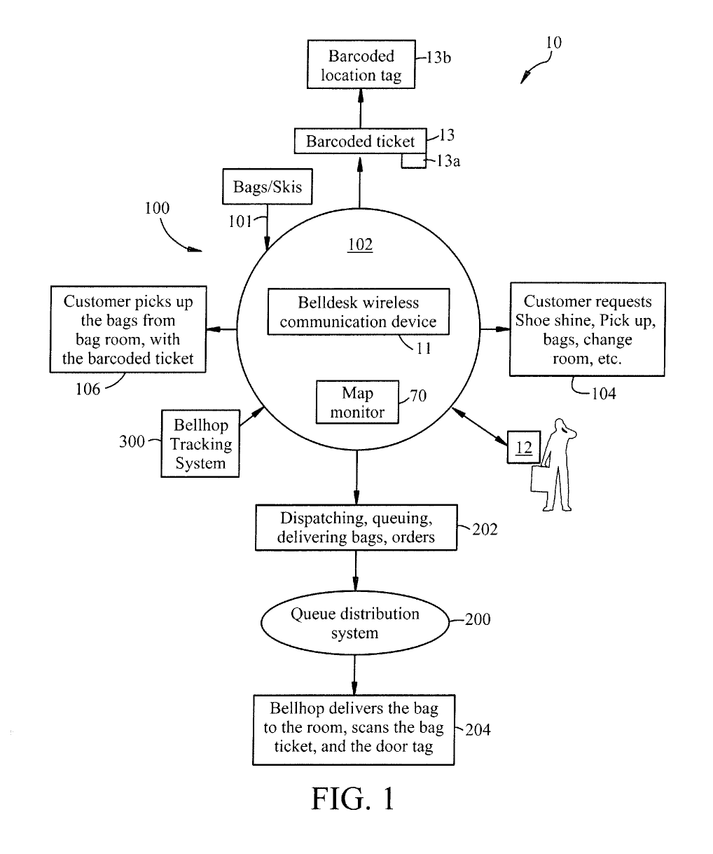

With reference to the drawings, FIGS. 1 to 8 depict an embodiment of the instant invention which is generally referenced as a bell desk queuing system, queuing system, system and, or by numeric character 10. The bell desk queuing system 10 comprises a computer and mobile media platform system for managing and tracking bell desk employees, hotel guests' bags/luggage and other belongings, for receiving customer requests and assigning employees to fulfill the requests and for monitoring employee performance. The bell desk queue system 10 of the instant invention provides a set of processor readable code comprising a storage room system 100 for handling bags and other customer property when they are checked in and out with the bell desk 102 and a queued job distribution and monitoring system 200. The storage room system 100 and job distribution and monitoring system 200 of the instant invention 10 are operated by a plurality of bell desk employee wireless mobile communication devices 12, a centralized bell captain wireless communication device 11, barcode customer (a/k/a “guests”) property tickets 13 that are created or preprinted for assigning to bags or other property handled by the bell desk 102, barcode location tags 13b corresponding to locations in the storage room, the software applications on the communication devices 11, 12 and a tracking system 300 for tracking employees and property.

The service employees or attendants are referred to equally herein as “bellman”, “bellhops”, “employees” or the like.

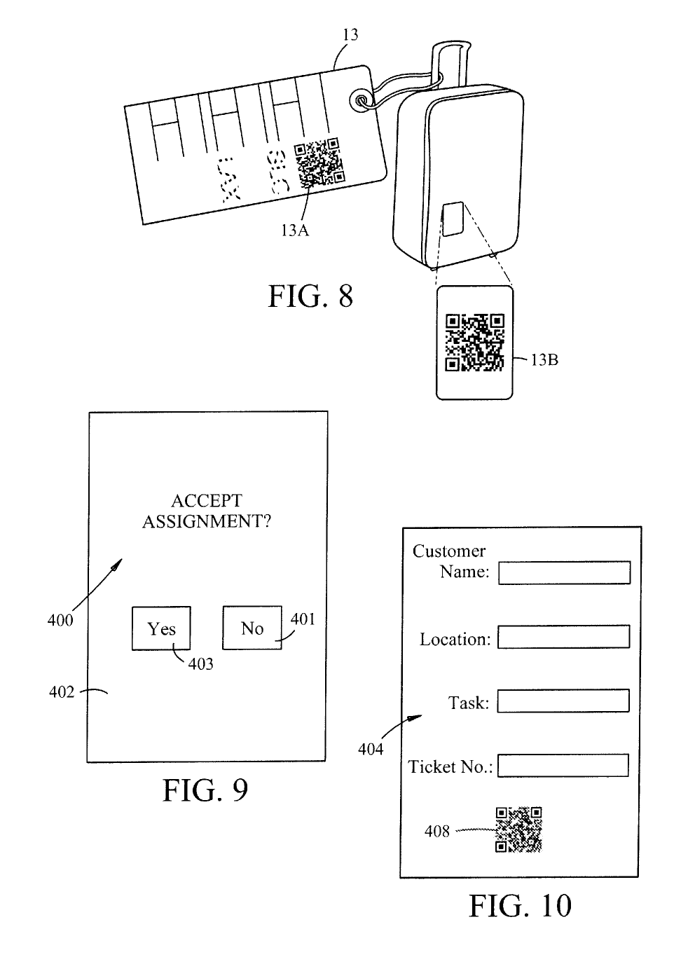

With reference to FIGS. 1 and 8, the storage room process 100 comprises a “receiving bags process” and “delivery process.” With the receiving bags process 100, the customer brings 101 their bags, skis or other property to the bell desk 102 for storage or handling. The bellman assigns a barcode ticket 13, either preprinted or created for each bag/property, enters the name of the corresponding customer, gives the customer a barcoded ticket 13, scans the barcode 13a on the ticket 13 attached to the bag/property, and takes a picture of each bag/property with his/her iPhone® or iPod® 12. The bellman takes the bags/property inside the storage room, puts the bags/property into a spot that was previously numbered with a barcode location tag 13b, scans the bag tickets 13a and scans the barcode location tag 13b to indicate the exact storage location in the storage room.

Still referring to FIGS. 1 and 8, the delivery process comprises a pick-up system 104-106 for handling customer bags/property when the customer returns to pick up the items and a job distribution and monitoring system 200 for handling the delivery of customer bags/property and processing other guests' requests. In the pick-up system 104-106, when the customer returns to pick up their bags/property, the bell captain scans the bag/property ticket barcode 13a and sends it to the system 10. The system 10 enters this request to the queue in the hell desk wireless communication device 11 and sends the message to the bellhop 12 to bring the bags/property to the bell desk 102 where the customer is located. The next or most available bellman selects the queued request from the list in the system and retrieves the bags/property from the proper storage location in the storage room and delivers it to the customer. The bellman then scans the customer tag 13 to tell the system 10 that the bags/property had been delivered to the guest. The job is then removed from the queue. With respect to the delivery system, once the customer checks in, the bell captain will cheek the queue list for the next or most available bellman and assigns the bags/property to the bellman for delivering to the customer's room. Whoever is next available picks up the bags/property and delivers them to the guest room and scans a barcode door tag from the room, which informs the system that the bags/property were delivered to the room and that the bellman is available to receive the next queue.

With reference to FIGS. 1-8, the bell desk queuing system 10 comprises a plurality of bell desk employee mobile communication devices 12, a hell captain communication device 11, created preprinted tickets 13 having two parts, software applications 12a-12f for operation on the communication device and tracking system. The bell desk employee mobile communication devices 12 preferably comprise iPhones® or comparable substitutes and the bell captain communication device 11 preferably comprises an iPad® or comparable communication device. Each bell desk employee is assigned an iPhone® 12 and the bell captain is assigned an iPad® The employee handheld device 12 preferably includes a camera for taking photographs of the bags to monitor proper handling. The photograph is stored on the ticket or ticket barcode to allow for the tracking of property damage and location. The software applications 100-200 run on the employees' mobile communication devices 12 and the bell captain's communication device 11.

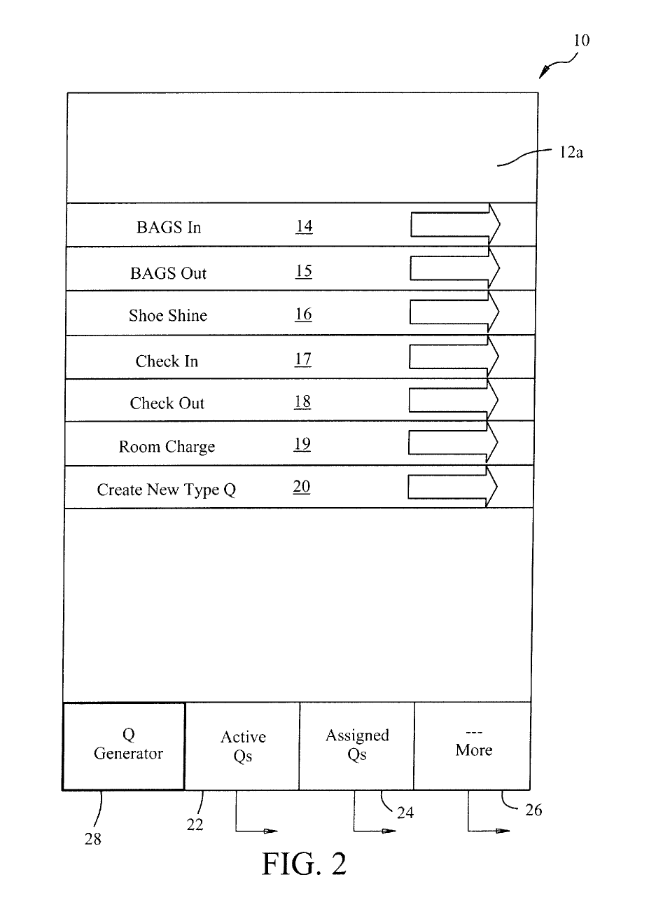

Referring to FIG. 2, the applications comprise a main screen 12a for selecting services such as identifying bags coming in 14, bags being checked out 15, checking in to the hotel 17 where a room number is identified for delivery of luggage, checking out of a hotel room 18 for identifying luggage to be picked up, room changes 19, shoe shines 16 and creating other queue services 20. The main screen 12a also activates queues 22, assigns queues 24, generates new queues 28 and monitors employees 26. Active queues 22 are pending customer requests. Assigned queues 24 are customer requests that have been assigned to an employee. The queue generator 28 allows the creation of special requests, such as, for example, flower delivery.

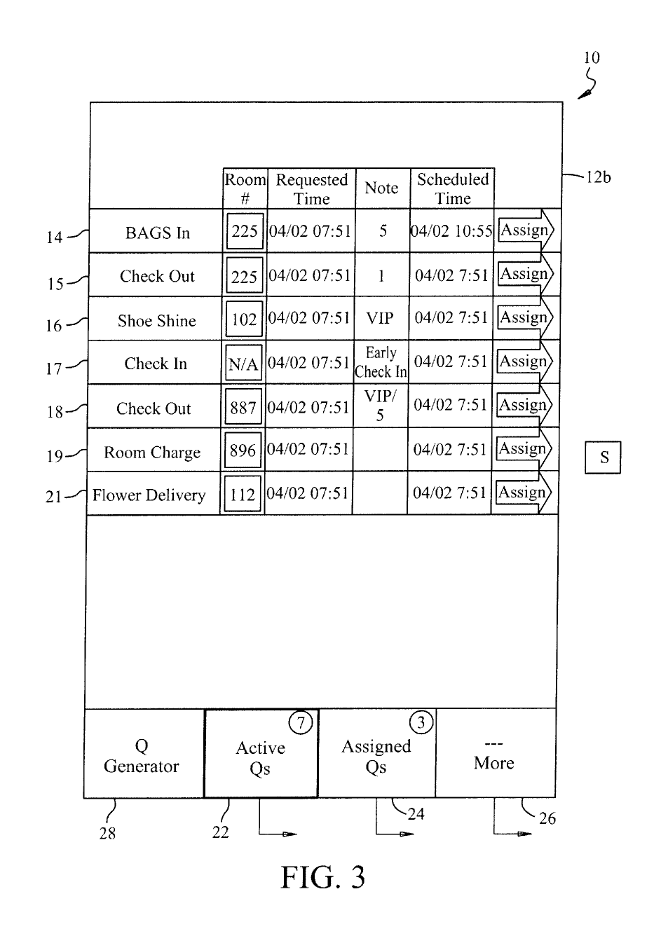

With reference to FIG. 3, an example of an active queues screen 12b as selected from the main screen active queues option 22 is shown. Pursuant to this screen, the room numbers, requested times, relevant notes and scheduled times are shown for bags in 14, bags out 15, shoe shine 16, check in 17, check out 18, room change 19 and flower delivery 21 are shown. There are seven active queues showing which is indicated in the “Active Q's” section. An active queue discloses pending hotel guest requests. The active queues screen 12b also shows that there are three assigned queues being processed by an employee.

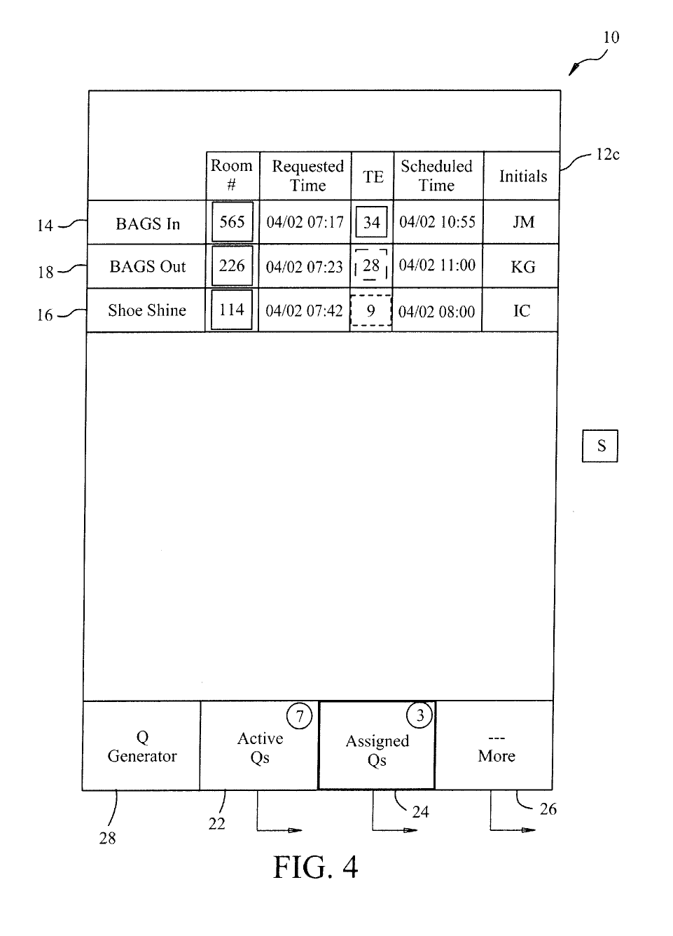

Referring to FIG. 4, the assigned queues screen 12c shows three requests being processed according to tasks, i.e. bags in 14, check out 18 and shoe shine 16, as well as the room number, requested time, time estimated (“TE”), scheduled time and initials of the attending employee. In the “TE” column, a red indicator for “bags in” indicates a thirty minute or more estimation of delivery. A yellow indicator for check out 18 indicates between ten and thirty minutes for delivery. A green indicator for shoe shine 16 indicates delivery or pickup in ten minutes or less.

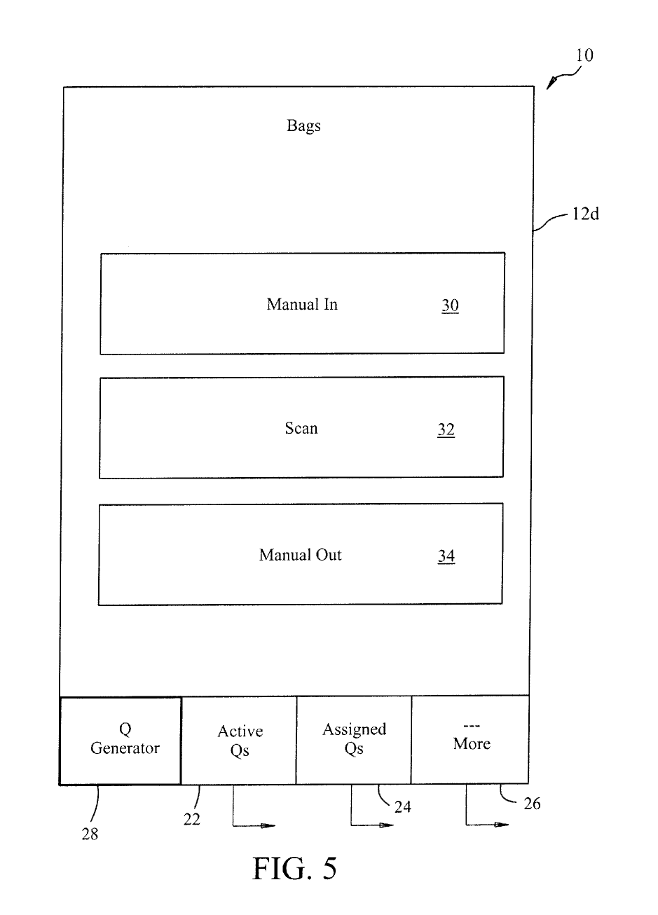

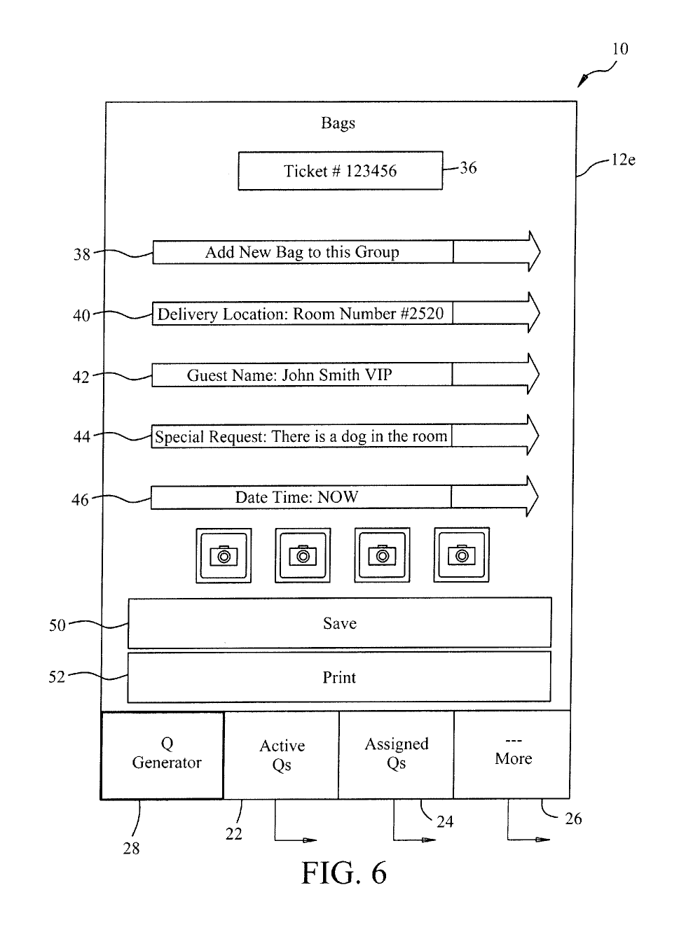

With reference to FIGS. 5 and 6, the bags or luggage handling main screens 12d and 12e are shown. As with the other screens, the bottom of the screen provides the active queues option 22, assigned queues option 24, employee monitoring option 26 and queue generator 28. The “manual in” option 30 enters bags being left with or handled by bell desk employees, the scan option 32 allows for scanning the corresponding luggage tickets, and the “manual out” option 34 is used when a customer receives their luggage.

Referring to FIG. 6, an example of a bags transaction 12e is shown. When a bag is received, a ticket number is provided 36 for the bag, the new bag is added to the group 38, the room number for delivery 40 is indicated, the guest name is provided 42, special requests are noted 44, the date and time are provided 46 and photographs 48 of the luggage are taken. The information may be saved and printed by selecting the save and print options 50 and 52. As with the other screens, the active queues option 22, assigned queues option 24, employee monitoring option 26 and queue generator option 28 are available.

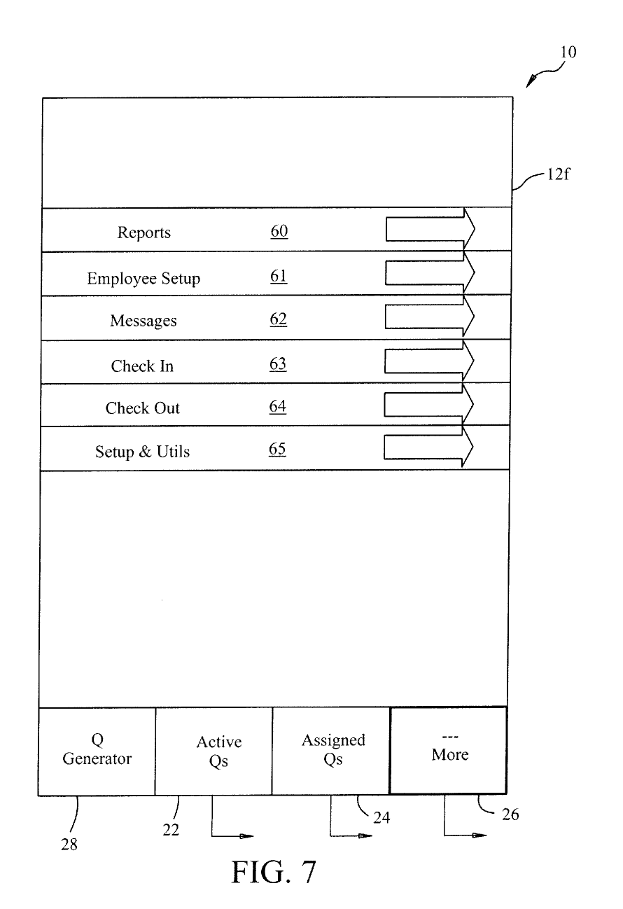

With reference to FIG. 7, the “more” or employee monitoring screen 12f is shown. The employee monitoring screen 12f provides reports 60, employee setup 61, messages 62, clock in time for work 63, clock out time 64 when leaving work and setup and utilities 65. The active queues option 22, assigned tasks queues option 24 and queue generator option 28 are also provided.

In accordance with the instant invention, bell desk employees carry iPhones® 12, and the bell captain will have an iPad® 11 for communicating with the iPhones®. Customers can request room changes 19, check in their bags 14, check out their bags 15, order a shoe shine 16, check in their rooms with their luggage being matched 17, check out of their rooms with matching luggage information 18 and new customer requests 20 may be created. For each request, the system 10 creates or provides a two-part barcoded ticket wherein one part is provided to the hotel guests. The system 10 matches the tickets with the guests, their belongings and requests. With reference to FIGS. 2-4, when a hotel guest checks in, they are given a ticket for each hag or piece of luggage and the bags are stored in a storage area or room and the hotel guest's room and other requests are noted and assigned to employees. With reference to FIGS. 5 and 6, when the bell desk employee stores the bags in the storage room, the employee takes a picture of the bags and the location indicator, which is a printed paper attached to the storage spot. The employee may also enter the location of the bags into the iPhone®. Once check-in is completed, a room number is available for delivering the bags and luggage and an employee is assigned the task of fulfilling the requests, as shown in FIGS. 3 and 4. Still referring to FIG. 4, the bell captain assigns the “request” for delivering the luggage to a bell desk employee, and whoever is next in the rotation and most conveniently available, receives the request message on their iPhone® to pick up the bag and deliver them to the requisite room. When an employee is delivering bags to a room, another request may he received by the bell captain. The bell captain can ascertain from the tracking system where the bell desk employees are located and assign the next request to the closest employee, most conveniently available employee, or some other criteria for assigning the next request job. Pursuant to the preferred embodiment of the instant invention, the bell desk queuing system streamlines the “next request” delivery process and also enables the monitoring and evaluation of employees.

The wireless bellhop management system allows a central office, such as a bell desk, front desk, or management office or the like, to communicate directly and in real time with one or all of the bellhops in the facility, regardless of where they are and regardless of what they are doing. This system enhances efficiency and customer service, reduces mistakes and long delays for bellhop assistance, and improves the ability to monitor and control bellhop operations. The system eliminates the need for manually entering or logging bellhop performance.

One of the main problems is that conventional bellhop systems lack real time communication between the bell desk and between the bellhops which are assisting customers. Accordingly, a bellhop delivering luggage to a room has no convenient or reliable way to know that there may be luggage in another adjacent or close-by room that needs to be retrieved—or that there are customers in nearby rooms that need assistance from a bellhop. With current practices, the bellhops are unaware of such situations until they return to the bell desk.

Conventional systems also do not have accurate and reliable systems for keeping track of the efficiency and responsibility of individual bellhops. At the present time, the bell captains and building management are only aware of the activities of the bellhops when they return to the bell desk.

Current systems also are unaware at all times of the locations of the individual bellhops in the facility, or outside the facility, or whether they are actively working on taking an unscheduled “break” somewhere.

One feature of a preferred embodiment of the invention is the placement of scannable, readable, electronic indicia, such as barcodes, at relevant locations throughout the hotel or other facility. These indicia could be placed in every room, in the hallways adjacent all or certain rooms, at relevant locations on a floor or hallway, near the elevators, or the like. The barcodes could be positioned on walls, columns, or any other convenient location. In this manner, after the bellhop has completed the assignment, the nearest barcode to that location can be scanned and relayed wirelessly back to the centralized wireless communication location, such as a central office (i.e. bell desk or front desk). These acts indicate that the bellhop is free or available for another task. That location and the identity of the bellhop are then placed in the central computer database and matched to an appropriate request, if any, by another hotel guest for assistance.

It is also preferable that a map of the hotel or facility be developed and made available on a monitor or the like 70 in the bellhop queue system, particularly for use by the centralized communication desk or office. In this manner, the actual physical location of each bellhop is shown or displayed in real time on the monitor or screen. This increases the speed and efficiency of the system.

When a customer request is recognized, information concerning the request is inputted into the system. This should indicate the name or identify of the customer, the location of the customer and the task or job that is requested. Preferably, the bellhop closest to the location of the guest or customer making the request is first notified and requested to go to that person and take care of the request. If the bellhop responds to the request that he or she will do so, that task request is indicated at the central wireless communication device as being satisfied. If the bellhop closest to the customer cannot or does not want to perform the task (for whatever reason), and declines it, then the bellhop whose last known location is second closest to the customer is notified and asked to take care of it. This procedure continues until a bellhop is found who agrees to take the assignment. Of course, if none of the bellhops are close to the customer, the request will be given to a bellhop at the base location (i.e. at the bell desk, front desk, etc.) and who is next in line for an assignment.

When there is a customer request for a bellhop for any reason, that request can be immediately and automatically provided wirelessly to all of the bellhops. The notice can be any “beep,” ring tone, chime or the like, along with an appropriate notice (text or email) on the screen on the handheld wireless devices. A statement or remark could also be part of the notice (e.g. “pick up laundry in Room ABC”).

The wireless bellhop queuing management system includes a plurality of individual handheld wireless communication devices 12 for the bellhops, and a communication network, such as a server, software, and database in a centralized dispatch office 102 (e.g. bell desk, front desk, management office). The central office or bell desk 102 preferably has an iPad® device 11 or equivalent, or a monitor for displaying relevant data. The centralized office can also have any handheld wireless communication device, such as an iPad®. The software program can provide numerous screens which advise the central office and bellhops of relevant data such as physical locations, and also allow real, time interaction and responses by the bellhops. The screens also can have “touch buttons” or other manual feedback options in which the bellhops can manually reply or respond to questions or statements presented on the screens.

The software in the handheld devices also can contain voice recognition software. In this manner, the bellhops can communicate and respond directly to alerts or notices with simple voice responses. The software converts the voice statements into text messages that appear on the handheld devices or monitors of the bell desk, central office, etc.

Similarly, if a barcode or other electronically readable indicia is scanned by a handheld device, that data is automatically sent directly to the server and database where information and data in that barcode or indicia is immediately displayed at the central office or other handheld devices as desired. In turn, the software immediately and outwardly responds or provides new job assignments to the bellhops where appropriate.

The scanner stores and transfers the data through the network to the server where it is decoded by the database. The data is also displayed at the central office, such as on a monitor, for action by the bell desk and other programs in the software. For example, if the bellhop is sending information or a data scan from a certain location indicating that his job assignment is finished, the system immediately knows that bellhop is available for assignment of another job, particularly jobs in his same relative location. The system then sends that bellhop the necessary information in order to allow him/her to take on that new assignment.

The wireless communication units are preferably handheld wireless devices known today, such as cellular telephones (iPhone®, Droids, etc.), Bluetooth® devices, Blackberry® devices, and the like. It is also preferred that the units include the ability to scan electronically reliable indicia, such as barcodes, and take digital pictures. The wireless communication units also could be custom or customized devices which have been made and programmed specifically for a certain building, company or group of bellhops.

It is also preferred that the wireless communication devices include a component or system which allows centralized station, such as a bell desk or the like, keep track in real time as to the location of each of the bellhops. The centralized station (bell desk, management office, etc.) also can have a screen or monitor system which displays in some manner the location of each handheld wireless device, and thus the location of the bellhops who has or is holding such a device.

The wireless communication devices should have applications programming capability, and are programmed with software allowing real time communication with the central office (e.g. bell desk), by email, text, or oral contacts.

The handheld devices being used by the bellhops have a unique positioning sensor or a global positioning system (“GPS”), which indicates the position or location of the bellhops at all times in the facility. These locations could all be indicated on a master map or monitor screen 70 which would allow the bell captain or dispatcher to visually see and be able to contact the bellhop (electronically or manually) who is physically closest to the location of a customer who has a task to be completed. In one embodiment, such notification is performed electronically (automatically) by a software system designed to designate the bellhops who are physically closest to a job assignment. The bellhop or bellhops who are closest to the guest are notified in the same manner as discussed above (by email, text, audio signal, etc.) and requested to contact the customer and take care of the request.

In order to save time relative to responding to customer requests, the system sends bellhops that are the closest or shortest distance to the location of the customer from the bell desk. Thus, when a customer makes a request, the computer decides which bellhop is closest to the customer and instructs the bellhop accordingly.

In still another embodiment, a plurality of video cameras are positioned throughout the building or facility. Each floor or areas of the building is then visually accessible on one or more monitors at the central office. With this system, the bellhops who are the closest to the customer are readily visible to the bell captain or central office. This system could also double as a security system and preferably be similar to multi-camera, multi-monitor security system in use today at numerous buildings and companies. If the video monitors visually show the locations of all the bellhops in the facility, and the location of the customer with the task is known, then the bell captain would be able to determine which bellhop shown on a monitor is the closest. One or more of the bellhops would then be notified in the manner discussed above, either electronically or by audio signal, and requested to contact the customer.

Once a bellhop indicates that he or she will contact the customer at issue and perform the assignment, the procedure shifts to the next customer with an open task.

As indicated, in accordance with the embodiment of the invention, customer requests will be distributed to bellhops based on their physical location and availability status. Depending on the status of the bellhop, which could be performing another task, waiting by the bell desk, etc., the system will note the bellhop's locations and place his or her availability for assignment accordingly.

A representative system which accomplishes this is shown in FIG. 9-15. When the bellhop is available, especially because his or her present or last known location is close to or the closest of all of the bellhops to the location of the customer with the assignment, the bellhop will receive an electronic message 400 on the screen 402 of his/her handheld device 12 as shown in FIG. 9. An audio signal can accompany the message to insure the bellhop will read it.

If the bellhop accepts the assignment, the “Yes” button 403 is pressed. If the bellhop declines the assignment, the “No” button 401 is pressed.

If the assignment is accepted, the system electronically sends details of the assignment information in a second screen 404, as shown in FIG. 10. The information includes the name of the customer (if known), the room number or location of the customer, and the task requested. If the customer request has a barcode associated with it, then the barcode 408 of that ticket is also displayed.

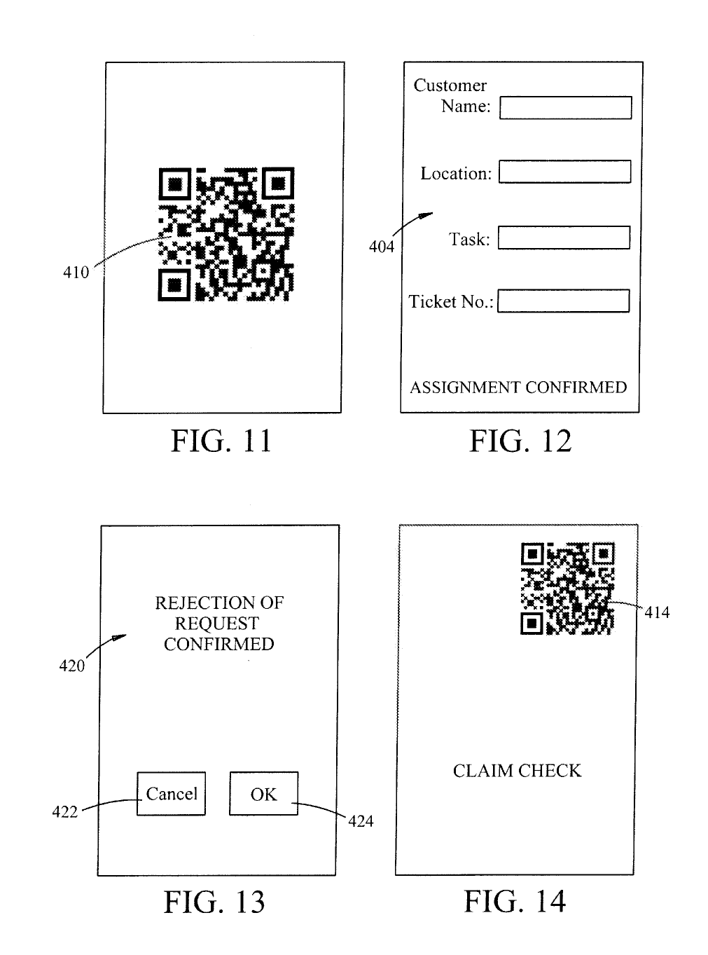

Once the bellhop reaches the customer, the bellhop scans the barcode 410 on the ticket portion, if any, with a handheld device 12. This is shown in FIG. 11. The system compares the scanned barcode 410 for the customer in the computer database and confirms that the assigned task is the correct one. This scan 412 is shown in FIG. 12.

If the bellhop denies the request, the “No” button 401 in FIG. 9 is pressed. The system then sends a message 420 to the bellhop confirming the denial, as shown in FIG. 13. A “Cancel” button 422 is also provided at this point in case the bellhop changes his/her mind and decides to accept the assignment. If so, electronic message 400 in FIG. 9 is resent and the steps shown in FIGS. 10-12 take place.

If the bellhop continues to deny the request, the “OK” button 424 is pressed. The task request is then immediately sent to the bellhop who is the next closest to the customer's location. This is discussed above.

The names of the bellhops who have denied retrieval requests can be placed in an “unavoidable status” for a certain length of time, such as 5 or 10 minutes. After that period of time has passed, the system automatically places the bellhop back on “availability status.” The bellhop can also scan a location indicia or barcode while under the unavailable status to go back to available status at any time.

The history of “denials” by the bellhops can also be kept in the computer records and taken into account periodically, particularly at his/her review.

As indicated, once the customer has made a request for assistance, that request is made to the first available bellhop. This is preferably the bellhop where his/her last known location is the closest to the customer's location. If the request is denied, it is offered to the next available bellhop and so on. If the request has been on the queue for more than a predetermined period of time, such as 5 minutes, and not agreed to be picked up by a bellhop in the facility, then the request is provided electronically to any bellhop, such as those at the bell desk, who wants to assist the customer. From the point, the bellhop can manually select the assignment from the request screen and complete the task.

As indicated above, a similar procedure can be used for the storage of bags and other items in the storage room. All the room, areas, shelves, stalls, and the like in the storage room are marked individually with electrically readable indicia, such as barcodes. Also, a map of the storage area is displayed on a screen or monitor with the barcode or other electronically readable indicia noted for each storage space. When the bags and other items are checked in for storage, each item is given its own ticket with a barcode. The centralized bell desk or office, then manually or automatically assigns a certain room, area, shelve, or stall for placement and storage of the item.

When the item is placed in the selected location, the bellhop can scan the electronically readable indicia, e.g. a barcode, at the location, such as 414 in FIG. 14. This automatically confirms the placement of the item which is stored in the memory of the centralized system. The location is also connected and correlated to the barcode or the like on the ticket, a portion of which is given to the guest.

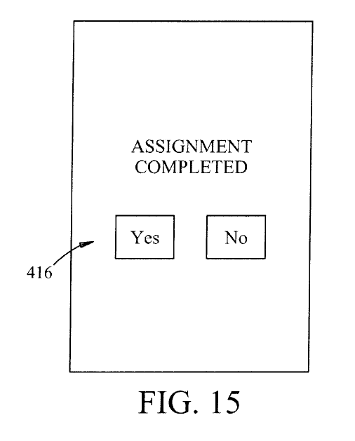

Later, when the guest wants to retrieve the item, the guest's ticket stub is read by the centralized system and shown on the monitor. This allows the bellhop to quickly go to the location of the item(s) in the storage area without having to manually search the entire area for the item(s). The bellhop also can see the barcode on the hag as well as in the area, shelve, etc. with handheld wireless communication devices. When the bellhop has successfully retrieved the bag or other item and returned it to the guest, the bellhop advises the centralized desk 102 with a notice, such as 416 in FIG. 15. This will advise the centralized wireless system that the bag has been retrieved and the bellhop is available for another assignment. This process increases the speed at which the items can be found and retrieved, and provides a more efficient system.

This embodiment of the invention allows faster and more efficient marking, storing and retrieving of bags and other items which are requested to be placed and stored in a hotel storage room or area.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

Although the invention has been described with respect to preferred embodiments, it is to be also understood that it is not to be so limited since changes and modifications can be made therein which are within the full scope of this invention as detailed by the following claims.

What is claimed is:

1. A method of servicing customers in a facility having a plurality of service attendants for servicing customers and attending to customer requests, said method comprising the steps of:
(a) providing unique electronically readable indicia at a plurality of locations in the facility designating said locations;
(b) providing the service attendants with electronic wireless handheld mobile devices, said devices being able to read and scan said unique electronically readable indicia at said plurality of locations;
(c) electronically notifying at least one of said service attendants of the location of a customer who has a job assignment request that needs to be serviced;
said at least one of said service attendants being the service attendant closest in physical location to the location of the customer whose request is to be serviced or the item requested to be serviced; and
(d) servicing the customer's request.

2. The method as described in claim 1 wherein a plurality of service attendants are provided to service requests by customers in the facility, and further comprising the step of electronically tracking the locations of each of said service attendants while each are in the parking facility.

3. The method as described in claim 2 wherein the electronic tracking is based on the location of each of said electronic wireless handheld mobile devices.

4. The method as described in claim 2 further comprising the step of electronically notifying a second service attendant who is physically near a location which has a customer to be serviced.

5. The method as described in claim 2 further comprising the step of electronically requesting at least one of said service attendants to service customers who made a request to be serviced.

6. The method as described in claim 1 further comprising the step of taking pictures of items requested by a customer to be serviced.

7. The method as described in claim 6 further comprising the step of entering said pictures into a computer memory.

8. A method of storing items in a storage facility, comprising:
(a) providing a ticket to a customer for a first item presented by a first customer for storage, said ticket having electronically readable indicia thereon;
(b) storing the electronically readable indicia into a computer memory;
(c) storing said first item by a first attendant at a first storage location in the storage facility, said first storage location having a unique electronically readable indicia identifying said first storage location; and
(d) entering said unique electronically readable indicia identifying said first storage location into said computer memory.

9. The method as described in claim 8 wherein step (d) of entering said unique electronically readable indicia identifying said first storage location is performed using a handheld mobile wireless device.

10. The method as described in claim 8 wherein said unique electronically readable indicia identifying said first storage location is a barcode.

11. The method as described in claim 8 further comprising the step of:
(e) electronically notifying said first attendant of a second item in the storage facility at a second storage location which needs to be retrieved while said first attendant is at or adjacent said first storage location.

12. The method as described in claim 11 further comprising the step of providing an electronic notification by said first attendant that said first attendant will retrieve said second item.

13. The method as described in claim 11 further comprising the steps of:
providing an electronic notification by said first attendant that said first attendant will not retrieve said second item; and
electronically notifying a second attendant that said second item needs to be retrieved.

14. The method as described in claim 11 further comprising the steps of providing electronic notification that second secured item has been retrieved.

15. The method as described in claim 8 further comprising the step of taking pictures of the first item prior to storing said first item in a first storage location.

16. The method as described in claim 8 further comprising the step of taking pictures of the first item and entering said pictures into said computer memory.

17. The method as described in claim 11 wherein the step (e) further comprises sending at least one picture of said second item to the first attendant.

18. A method of retrieving stored items in a storage facility having a plurality of service attendants for storing and retrieving stored items for customers, and method comprising the steps of:
(a) providing unique electronically readable indicia at each storage location in the storage facility;
(b) providing the service attendants with electronic wireless handheld mobile devices, said devices being able to read and scan said unique electronically readable indicia at said storage locations;
(c) electronically tracking the physical location of said service attendants in the parking facility;
(d) electronically notifying at least one of said service attendants of the location of a customer who has an item to be retrieved form the storage facility;
said at least one of said service attendants being the service attendant who is closest in physical direction to the location of the customer; and
(e) retrieving the stored item from said storage facility and providing it to a customer.

19. The method as described in claim 18 further comprising the step of electronically notifying at least one service attendant who is physically at a location near the storage facility that a stored item needs to be retrieved and returned to a customer.

20. The method as described in claim 19 further comprising the step of electronically requesting at least one of said near service attendants to retrieve a stored item.

21. The method as described in claim 18 wherein said electronic tracking is based on the location of said electronic wireless handheld mobile devices.

22. The method as described in claim 18 further comprising the step of taking pictures of the stored item prior to retrieving said item in the storage facility.

23. The method as described in claim 22 further comprising the step of entering said pictures into a computer memory.

24. The method as described in claim 18 further comprises sending to a service attendant at least one picture of an item to be retrieved from the storage facility.
